(19) United States
(12) Patent Application Publication
(10) Pub. No.: US 2025/0305984 A1
(43) Pub. Date: Oct. 2, 2025

(54) ELECTROPHORESIS DATA PROCESSING DEVICE AND ELECTROPHORESIS DATA PROCESSING METHOD

(71) Applicant: HITACHI HIGH-TECH CORPORATION, Tokyo (JP)

(72) Inventors: Naoya Murooka, Tokyo (JP); Motohiro Yamazaki, Tokyo (JP); Noriyuki Sumida, Tokyo (JP); Isao Haraura, Tokyo (JP); Daisuke Morishima, Tokyo (JP); Toshiaki Yanokura, Tokyo (JP)

(73) Assignee: HITACHI HIGH-TECH CORPORATION, Tokyo (JP)

(21) Appl. No.: 18/855,722

(22) PCT Filed: May 20, 2022
(86) PCT No.: PCT/JP2022/020965

§ 371 Date: Oct. 10, 2024

(51) Int. Cl. G01N 27/447; G01N 21/64

(52) U.S. Cl. CPC G01N 27/44782; G01N 21/64

(57) ABSTRACT

Disclosed is an electrophoresis data processing device that is configured to provide support for efficient analysis of electrophoresis results. The electrophoresis data processing device includes a fluorescence calibration section, a color conversion processing section, an intensity correction coefficient determination section, an intensity adjustment processing section, and a display device. The fluorescence calibration section calculates fluorescence spectrum data of a second sample in accordance with signal change data of a second sample. The color conversion processing section calculates fluorescence color signal data in accordance with signal charge data of a third sample and with the fluorescence spectrum data, and calculates fluorescence color signal data in accordance with signal charge data of a first sample and with the fluorescence spectrum data. The intensity adjustment processing section calculates color signal data by using the fluorescence color signal data and an intensity correction coefficient. The display device outputs the color signal data.

### TECHNICAL FIELD

The present invention relates to a technology for an electrophoresis data processing device and an electrophoresis data processing method.

### BACKGROUND ART

Capillary array electrophoresis devices (hereinafter referred to as the electrophoresis devices) for analyzing base sequence information regarding DNA (Deoxyribonucleic Acid) are known. In the electrophoresis devices, a sample in which DNA is labeled with a plurality of fluorescent labels is electrophoresed inside a capillary. The electrophoresis devices are configured such that, when the sample is electrophoresed, the detection region of the capillary is irradiated with excitation light, and that the fluorescence emitted by the fluorescent labels is detected as a signal. The fluorescence emitted by the sample is dispersed in the wavelength direction and detected as a fluorescence signal by a device for converting an optical signal into an electrical signal for each wavelength region, such as a CCD (Charge Coupled Device) element or a CMOS element.

A binning function is known in which, when a fluorescence signal is to be acquired, a plurality of light-receiving surfaces (corresponding to pixels) in an element are pseudo-combined and treated as one pixel, thereby increasing or decreasing the light-receiving area per pixel. Disclosed, for example, in Patent Document 1 are a capillary array electrophoresis device, a fluorescence detection device, and a fluorescence signal intensity acquisition method. The fluorescence detection device 400 has a plurality of light-receiving surfaces, which generate signal charges when irradiated with a fluorescence signal 405, and acquires a fluorescence signal intensity based on the plurality of signal charges generated on the light-receiving surfaces. The fluorescence detection device 400 acquires the fluorescence signal intensity by performing either hardware binning, which acquires the fluorescence signal intensity by collectively converting the plurality of signal charges, or software binning, which converts the signal charges one by one into fluorescence signal intensity, and adds up the resulting fluorescence signal intensities to acquire the fluorescence signal intensity (refer to Abstract). The combination of a plurality of binning regions applied during binning is called a binning pattern.

### CITATION LIST

### Patent Literature

Patent Literature 1: Japanese Unexamined Patent Application Publication No. 2015-49179

### SUMMARY OF INVENTION

### Technical Problem

In the electrophoresis devices, it is necessary to simultaneously detect and analyze the fluorescence derived from a plurality of fluorescent labels, and satisfactory analysis results cannot be obtained if variation in fluorescence sensitivity is not suppressed.

The binning function described in Patent Document 1 is able to improve the data acquisition speed and the S/N ratio. However, when the binning region is to be adjusted to improve the S/N ratio, it is necessary to make improvements to avoid variation in fluorescence sensitivity that may occur depending on the wavelength characteristics of the fluorescent labels.

Consequently, when the binning function was available, a binning pattern optimized for a set of fluorescent labels was applied to suppress variation in fluorescence sensitivity.

However, due to an increase in fluorescence detection speed and a decrease in acquisition pixel area, there are cases where data can be acquired without the binning function. In such cases, since the binning function itself is not available, the variation in fluorescence sensitivity cannot be suppressed although it has been successfully suppressed by applying the binning pattern. Therefore, a method for suppressing the variation in fluorescence sensitivity without being dependent on binning is required.

The present invention has been made in view of the above circumstances. An object of the present invention is to provide support for efficient analysis of electrophoresis results.

### Solution to Problem

In order to solve the above problem, according to an aspect of the present invention, there is provided an electrophoresis data processing device including a fluorescence spectrum calculation section, a fluorescence color signal data calculation section, an intensity correction coefficient calculation section, a color signal data calculation section, and an output section. The fluorescence spectrum calculation section calculates fluorescence spectrum data, which is data obtained by normalizing a wavelength spectrum of a signal charge value of fluorescent labels used for a first reference sample in accordance with first signal charge data, which is a result of electrophoresis regarding the first reference sample that is a sample for calibrating data from a real sample. The fluorescence color signal data calculation section calculates second fluorescence color signal data and third fluorescence color signal data. The second fluorescence color signal data, which is chronological information regarding the signal intensity of each of the fluorescent labels, is calculated in accordance with second signal charge data and with the fluorescence spectrum data. The second signal charge data is a result of the electrophoresis regarding a second reference sample that is a sample for evaluating or calibrating data from the real sample. The third fluorescence color signal data, which is chronological information regarding the signal intensity of each of the fluorescent labels, is calculated in accordance with third signal charge data and with the fluorescence spectrum data. The intensity correction coefficient calculation section calculates, in the second fluorescence color signal data, an intensity correction coefficient that is a ratio between a predetermined reference signal intensity of the fluorescent labels and the signal intensity of each of the fluorescent labels. The color signal data calculation section calculates color signal data by multiplying each data on the fluorescent labels of the third fluorescence color signal data by a corresponding intensity correction coefficient. The output section outputs the color signal data.

### Advantageous Effects of Invention

The present invention makes it possible to provide support for efficient analysis of electrophoresis results.

### BRIEF DESCRIPTION OF DRAWINGS

FIG. 1 is a diagram schematically illustrating an example of the configuration of an electrophoresis system according to a first embodiment.

FIG. 2A is a diagram illustrating an example of the configuration of an electrophoresis device.

FIG. 2B is an enlarged view of a capillary cathode end.

FIG. 3A is a diagram illustrating an example of a detection section of the electrophoresis device.

FIG. 3B is a schematic cross-sectional view of a portion of the detection section taken along a plane perpendicular to a capillary.

FIG. 4 is a flowchart illustrating processing steps performed by the electrophoresis device according to the first embodiment.

FIG. 5 is a diagram illustrating an example of signal charge data.

FIG. 6 is a flowchart illustrating processing steps performed by the fluorescence calibration section according to the first embodiment.

FIG. 7 is a diagram illustrating an example of fluorescence spectrum data.

FIG. 8 is a flowchart illustrating processing steps performed by the fluorescence calibration section according to the first embodiment.

FIG. 9 is a diagram illustrating an example of fluorescence color signal data.

FIG. 10 is a flowchart illustrating processing steps performed by the intensity correction coefficient determination section according to the first embodiment.

FIG. 11 is another diagram illustrating an example of fluorescence color signal data.

FIG. 12 is a flowchart illustrating processing steps performed by the intensity adjustment processing section according to the first embodiment.

FIG. 13 is a diagram illustrating an example of color signal data.

FIG. 14A is a table illustrating examples of evaluation values for individual capillaries and individual fluorescent labels.

FIG. 14B is a table (part 1) illustrating examples of an intensity correction coefficient calculated based on the evaluation values.

FIG. 14C is a table (part 2) illustrating examples of an intensity correction coefficient calculated based on the evaluation values.

FIG. 15A is a diagram (part 1) illustrating an example of a menu screen.

FIG. 15B is a diagram illustrating an example of an alert screen.

FIG. 15C is a diagram (part 2) illustrating an example of a menu screen.

FIG. 15D is a diagram illustrating an example of a color intensity adjustment screen.

FIG. 16 is a diagram illustrating an example of the configuration of an electrophoresis device in the second embodiment.

FIG. 17 is a diagram illustrating an example of the hardware configuration of an electrophoresis data processing device.

### DESCRIPTION OF EMBODIMENTS

Modes for carrying out the present invention (referred to as the “embodiments”) will now be described in detail with reference to the accompanying drawings as appropriate. Component elements similar to each other in the accompanying drawings are denoted by the same reference signs and will not be redundantly described.

### First Embodiment

### <System Configuration Diagram>

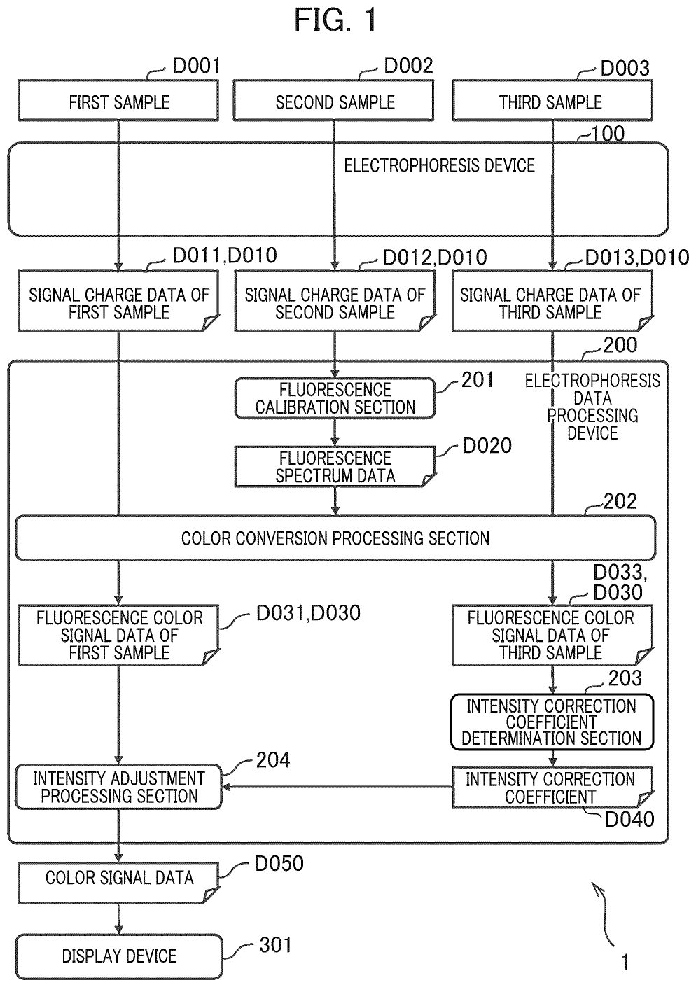

FIG. 1 is a diagram schematically illustrating an example of the configuration of an electrophoresis system 1 according to a first embodiment.

The electrophoresis system 1 includes an electrophoresis device 100, an electrophoresis data processing device 200 and a display device 301.

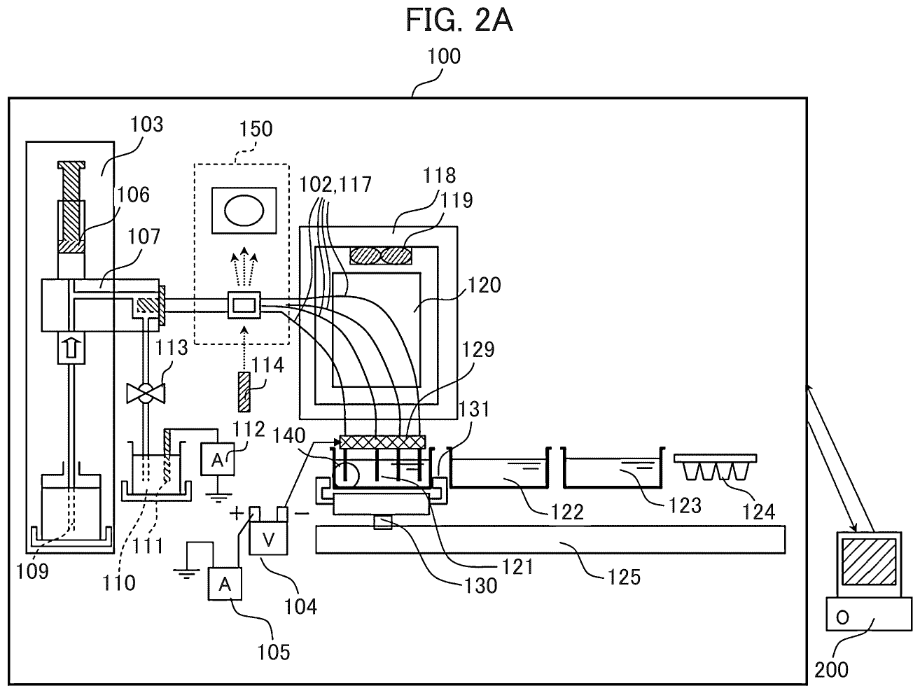

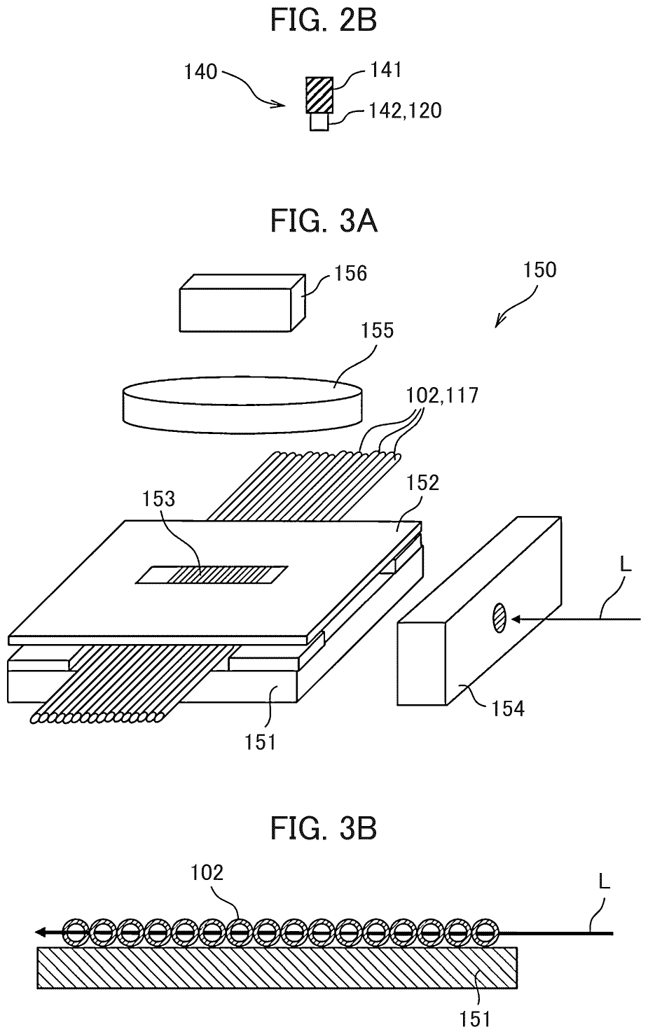

In the first embodiment, a first sample (real sample) D001, a second sample (first reference sample) D002, and a third sample (second reference sample) D003, which are all different from one another, are used to eventually output color signal data D050 of the first sample D001. Further, the first sample D001, the second sample D002, and the third sample D003 are labeled with a plurality of fluorescent labels of the same type. In the present embodiment, the second sample D002, the third sample D003, and the first sample D001 are caused to flow in this order through each of the capillaries 102 (see FIG. 2A) included in the electrophoresis device 100. Furthermore, in some cases, the first sample D001, the second sample D002, and the third sample D003 are collectively referred to as the samples.

The electrophoresis device 100 electrophoreses the samples and acquires signal charge data D011 to D013 (D010) of the first to third samples D001 to D003, respectively. The signal charge data D011 to D013 (D010) will be described later. For example, when the first sample D001, which is a measurement target sample (real sample), is subjected to electrophoresis in the electrophoresis device 100, the signal charge data (third signal charge data) D011 of the first sample D001 is obtained. That is to say, the signal charge data D011 of the first sample D001 is the result of electrophoresis of the first sample D001.

The same is true for the signal charge data (first signal charge data) D012 of the second sample D002 and the signal charge data (second signal charge data) D013 of the third sample D003. That is to say, the signal charge data D012 of the second sample D002 is the result of electrophoresis of the second sample D002. The signal charge data D013 of the third sample D003 is the result of electrophoresis of the third sample D003.

The first sample D001 to be measured by the electrophoresis device 100 is a real sample of DNA molecules or of a reagent, which are labeled with a plurality of fluorescent labels. When the DNA molecules are used as the first sample D001, it is assumed that fluorescent labels are attached to the base information (GATC) and characteristic base sequence structure (e.g., a portion where the same base sequence loops) of the DNA molecules. In the present embodiment, it is assumed that four types of fluorescent labels (a first fluorescent label, a second fluorescent label, a third fluorescent label, and a fourth fluorescent label) are used. However, the fluorescent labels used are not limited to four types. Further, the DNA molecules used as a real sample are referred to as a DNA sample as appropriate.

The second sample D002 is used to calculate later-described fluorescence spectrum data D020 (e.g., a matrix standard). The second sample D002 is a sample for calibrating data from the first sample D001, which is a real sample. More specifically, the second sample D002 is electrophoresed in advance prior to measurement using the first sample D001, which is a real sample, and is generally a sample used for performing wavelength calibration of fluorescence in order to suppress false signals. The second sample D002 is also labeled with the same fluorescent labels (the first to fourth fluorescent labels in the present embodiment) as the first sample D001. Electrophoresis results of the second sample D002, which are obtained when the second sample D002 is observed by electrophoresis, have independent peaks that do not overlap from one fluorescent label to another.

The third sample D003 is a sample for calculating a later-described intensity correction coefficient D040 (a sample for determining the intensity correction coefficient). The third sample D003 is a sample for evaluating data from the first sample D001. More specifically, it is assumed that the third sample D003 is a sample in which the difference in luminance between the fluorescent labels is reflected in a fluorescence color signal intensity, and is similar in luminance to the first sample D001. For example, an allelic ladder or a sample uniquely designated by a user may be used as the third sample D003. The allelic ladder is a reference sample that is electrophoresed in advance prior to measurement using the first sample D001, which is a real sample, and used to allow the user to recognize the length of the DNA molecules in the first sample D001. The allelic ladder is labeled with the same fluorescent labels (the first to fourth fluorescent labels in the present embodiment) as the first sample D001, and is characterized in that the electrophoresis results have peaks appearing at specific base length intervals for each fluorescent label. Both the first sample D001 and the allelic ladder are electrically induced to compare the first sample D001 and the allelic ladder and thus determine the base length of the DNA molecules of the first sample D001.

The electrophoresis data processing device 200 performs a color intensity adjustment process of uniformizing the fluorescence color signal intensity of the signal charge data D011 obtained from the electrophoresis device 100. The electrophoresis data processing device 200 includes a fluorescence calibration section (fluorescence spectrum calculation section) 201, a color conversion processing section (fluorescence color signal data calculation section) 202, an intensity correction coefficient determination section (intensity correction coefficient calculation section) 203, and an intensity adjustment processing section (color signal data calculation section) 204.

The fluorescence calibration section 201 calculates fluorescence spectrum data D020 based on the signal charge data D012 of the second sample D002, and passes the calculated fluorescence spectrum data D020 to the color conversion processing section 202. The fluorescence spectrum data D020, which will be described later, is data obtained by normalizing the wavelength spectrum of the signal charge value of the fluorescent labels used for the second sample D002.

The color conversion processing section 202 calculates fluorescence color signal data (second fluorescence color signal data) D033 (D030) of the third sample D003 in accordance with the signal charge data D013 of the third sample D003 and with a fluorescence spectrum matrix. The fluorescence color signal data D033, which will be described later, is chronological information regarding the signal intensity (fluorescence color signal intensity) of each fluorescent label. Additionally, the color conversion processing section 202 calculates fluorescence color signal data (third fluorescence color signal data) D031 (D030) of the first sample D001 in accordance with the signal charge data D011 of the first sample D001 and with a fluorescence spectrum matrix. The fluorescence color signal data D031, which will be described later, is chronological information regarding the signal intensity of each fluorescent label.

The intensity correction coefficient determination section 203 calculates an intensity correction coefficient D040, which is the ratio of the signal intensity of each fluorescent label to a predetermined reference fluorescent label signal intensity in the fluorescence color signal data D033. The intensity correction coefficient D040 will be described later.

The intensity adjustment processing section 204 calculates the color signal data D050 by multiplying each piece of fluorescent label data in the fluorescence color signal data D031 by a corresponding intensity correction coefficient D040.

The display device (output section) 301 displays (outputs), for example, the color signal data DO50, which is calculated by the intensity adjustment processing section 204.

Although the sections 201 to 204 are independently depicted in FIG. 1, at least two of the sections 201 to 204 may be integrated into one section. Further, the sections 201 to 204 may be each configured to perform processing by using one or more central processing units (CPUs).

Furthermore, FIG. 1 indicates that all of the sections 201 to 204 are included in the electrophoresis data processing device 200. Alternatively, however, each of the sections 201 to 204 may have one or more external component elements. For example, the electrophoresis data processing device 200 and the electrophoresis device 100 may be integrated into one device. Alternatively, at least one of the sections 201 to 204, such as the fluorescence calibration section 201, may be installed outside the electrophoresis data processing device 200.

### (Electrophoresis Device 100)

FIG. 2A is a diagram illustrating an example of the configuration of an electrophoresis device 100.

As depicted in FIG. 2A, the electrophoresis device 100 includes a detection section 150, a thermostatic chamber 118, and a conveyor 125. The detection section 150 optically detects a sample. The thermostatic chamber 118 maintains the capillaries 102 at a constant temperature. The conveyor 125 transports various containers to the cathode ends of the capillaries 102. Further, the electrophoresis device 100 includes a high-voltage power supply 104, a first ammeter 105, and a second ammeter 112. The high-voltage power supply 104 applies a high voltage to the capillaries 102. The first ammeter 105 detects a current generated from the high-voltage power supply 104. The second ammeter 112 detects a current flowing through an anode electrode. The second ammeter 112 is connected to a GND (Ground) electrode 111 that is installed in an anode buffer container 110. Furthermore, the electrophoresis device 100 includes a capillary array 117 and a pump section 103. The capillary array 117 is formed by one or more capillaries 102. The pump section 103 injects a polymer into the capillaries 102.

The capillary array 117 is a replacement member including a plurality of capillaries 102 (four capillaries in the example depicted in FIG. 2A), and includes a load header 129, a detection section 150, and a capillary head. When changing the method of measurement, the user replaces the capillary array 117 and adjusts the length of the capillaries 102. Further, when the capillaries 102 are damaged or deteriorated in quality, the user replaces the capillary array 117 with a brand new one.

The capillaries 102, which are electrophoresis paths for electrophoretically separating the samples by distributing the samples (distributing the first sample D001, the second sample D002, and the third sample D003), are each formed by a glass tube having an inside diameter of several tens to several hundreds of micrometers and an outside diameter of several hundreds of micrometers. The surface of each capillary 102 is coated with polyimide to improve its strength. However, in the detection section 150 where laser light L (excitation light: dotted arrows in FIG. 2A: see FIGS. 3A and 3B) is emitted, the polyimide coating is removed from the capillaries 102 so that internal emitted light easily leaks to the outside. The inside of each capillary 102 is filled with a separation medium for giving an electrophoresis speed difference during electrophoresis. Existing separation media are either fluid or nonfluid. In the present embodiment, however, a polymer, which is fluid, is used as the separation medium.

The detection section 150 acquires sample-dependent information. During electrophoresis, the laser light L (see FIGS. 3A and 3B) is emitted to pass through all the capillaries 102 in succession. As described above, the laser light L generates fluorescence having a wavelength that is dependent on the fluorescent label attached to a sample. When the above-mentioned fluorescence is detected, the sample is analyzed.

As depicted in FIG. 2B, capillary cathode ends 140 are fixed through metallic hollow electrodes 141, and the tips 142 of the capillaries 102 are extended from the hollow electrodes 141 by approximately 0.5 mm. Further, all of the hollow electrodes 141 disposed in the capillaries 102 are integrally attached to the load header 129 depicted in FIG. 2A. Furthermore, all the hollow electrodes 141 are connected to the high-voltage power supply 104 through the load header 129. The hollow electrodes 141 function as a cathode electrode when a voltage needs to be applied, for example, for electrophoresis or sample introduction.

The ends (other ends) of the capillaries 102, which are positioned opposite to the capillary cathode ends 140, are bound together by the capillary head (not depicted). The above-mentioned other ends of the capillaries 102 are members that are bundled and attached and detached in a pressure-resistant, airtight manner. The capillary head can be connected to a block 107 in a pressure-resistant, airtight manner. Accordingly, a new polymer is filled into the capillaries 102 from the other ends by using a syringe 106. It is desirable that the polymer filled into the capillaries 102 be refilled for each measurement in order to improve the measurement performance.

The pump section 103 pressurizes the syringe 106. The block 107 is a connection section for connecting the syringe 106, the capillary array 117, the anode buffer container 110, and a polymer container 109.

A light source 114 irradiates the detection section 150 with the laser light L (see FIGS. 3A and 3B). The detection section 150 will be described later.

The thermostatic chamber 118 is covered with a heat insulating material to keep the inside at a constant temperature. The temperature of the thermostatic chamber 118 is controlled by a heating and cooling mechanism 120. Further, a fan 119 circulates and stirs the air in the thermostatic chamber, thereby keeping the temperature of the capillary array 117 uniform and constant at various positions.

The conveyor 125 includes three electric motors and linear actuators, and is capable of moving in three axes, namely, up/down, left/right, and depth directions. Further, at least one container can be placed on a moving stage 130 of the conveyor 125. Furthermore, the moving stage 130 includes an electric grip 131, which is able to grip and release each container. Therefore, a buffer container 121, a cleaning container 122, a waste liquid container 123, and a sample container 124 can be conveyed to the capillary cathode ends 140 as needed. Any unnecessary containers are stored in a predetermined storage area in the electrophoresis device 100.

Further, the electrophoresis device 100 is used in a state where it is connected to the electrophoresis data processing device 200 via a communication cable. The user is able to control the functions of electrophoresis device 100 by using the electrophoresis data processing device 200, and thus able to exchange data detected by the detection section 150 of the electrophoresis device 100.

### (Detection Section 150)

FIG. 3A is a diagram illustrating an example of a detection section 150 of the electrophoresis device 100. FIG. 3B is a schematic cross-sectional view of a portion of the detection section 150 taken along a plane perpendicular to a capillary 102. FIG. 2 will be referenced as appropriate.

The detection section 150 includes a planar ceramic substrate 151, a lid 152, a shutter 154, an imaging optical lens 155 and an optical detector 156.

As depicted in FIG. 2A, the detection section 150 detects light that is emitted from a sample due to the laser light L emitted from the light source 114. This results in the detection of fluorescence that is emitted from the fluorescent labels in the DNA sample separated by electrophoresis.

In the example depicted in FIGS. 3A and 3B, unlike FIG. 2A, sixteen capillaries 102 are arranged on a capillary retaining surface, which is a flat surface of the planar ceramic substrate 151, and fixed, for example, with an adhesive to form the capillary array 117. In the above-described manner, the vicinity of locations of the plurality of capillaries 102 where the laser light L is emitted is arranged and fixed on an optical flat surface with a height accuracy of several micrometers. Each capillary 102 is a glass tube that is made of quartz and covered with a thin polymer film. However, quartz is exposed because the polymer film is removed from a location corresponding to an opening 153 provided in the lid 152. The inside diameter and outside diameter of the glass tube is 50 μm and 323 μm, respectively, and the outside diameter of each capillary 102 including the thin polymer film is 363 μm.

As described above, the number of capillaries 102 is sixteen. As depicted in FIG. 3B, the laser light L is first emitted to the capillary 102 at the right end of FIG. 3B. Then, after passing through the right-end capillary 102, the laser light L irradiates the next capillary 102. In the above-described manner, the laser light L passes through the capillaries 102 one after another, and is emitted from the capillary 102 at the opposite end. Each capillary 102 is cylindrical in shape and filled with a polymer. Therefore, each capillary 102 provides a light-gathering function similar to that of a convex lens. This function suppresses the divergence of the laser light L. In the present embodiment, the laser light L is emitted from one direction. However, when the laser light L is emitted to the capillary array 117 from both the left and right directions, it is possible to irradiate substantially all the capillaries 102 with the laser light L having a uniform intensity. Therefore, samples distributed through the sixteen capillaries 102 can be detected simultaneously without sacrificing high sensitivity.

When the laser light L is emitted, the fluorescent labels in the DNA sample emit fluorescence. The fluorescence emitted from the fluorescent labels passes through the opening 153, and causes the imaging optical lens 155 to form the image on the optical detector 156. The optical detector 156 outputs the above-mentioned signal charge data D010 (see FIG. 1).

Under normal conditions, the laser light L is continuously outputted during analysis. However, the shutter 154 controls the time during which the samples distributed inside the capillaries 102 are irradiated with the laser light L. The electrophoresis data processing device 200 (see FIGS. 1 and 2A) synchronizes the timing of opening/closing of the shutter 154 with the timing of data acquisition by the optical detector 156 in order to control the time during which the capillaries 102 are irradiated. Further, the electrophoresis data processing device 20 controls, for example, the intensity of the laser light L so that the signal value acquired by the optical detector 156 does not become saturated.

It should be noted that the electrophoresis device 100 used in the present embodiment does not necessarily include the component elements depicted in in FIGS. 2A to 3B.

### (Processing by Electrophoresis Device 100)

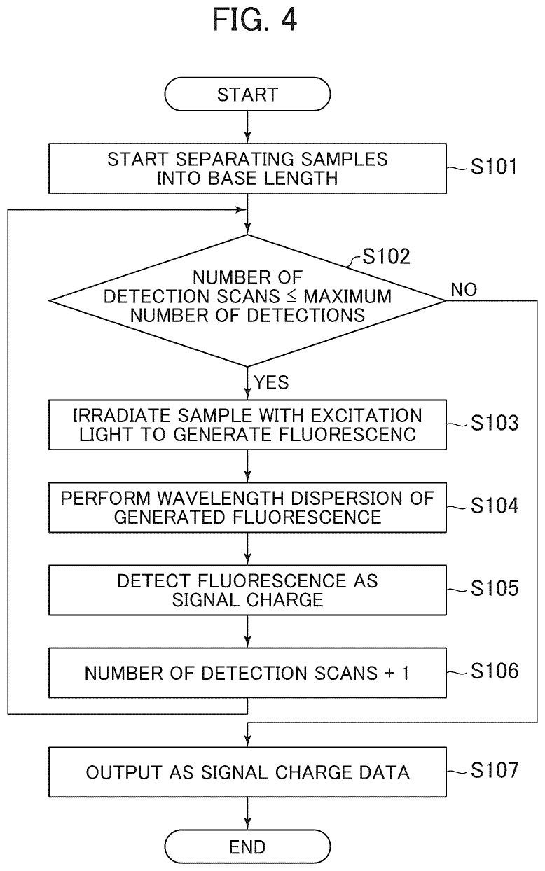

FIG. 4 is a flowchart illustrating processing steps performed by the electrophoresis device 100 according to the first embodiment. FIG. 1 and FIG. 2 will be referenced as appropriate. In the electrophoresis device 100, the first sample D001, the second sample D002, and the third sample D003 are each subjected to electrophoresis.

The electrophoresis device 100 outputs the signal charge data D010 in accordance with the process flow depicted in FIG. 4.

First of all, the electrophoresis device 100 starts separating the samples into a predetermined base length by applying a voltage to an electrophoresis solvent (step S101). In this instance, the number of detection scans is initialized. The number of detection scans is the number of times a scan has been performed, that is, the number of times the shutter 154 depicted in FIG. 3A has been opened. Since the samples are flowing through the capillaries 102, each time the shutter 154 opens, the substance flowing through the inside of the capillaries 102 is detected. The scans are preset so as to cover the maximum number of detections.

Subsequently, the electrophoresis device 100 determines whether the number of detection scans is equal to or less than the maximum number of detections (step S102).

If the number of detection scans is equal to or less than the maximum number of detections (“YES” at step S102), the light source 114 of the electrophoresis device 100 irradiates the samples with the excitation light (laser light L) to generate fluorescence (step S103).

Subsequently, the detection section 150 of the electrophoresis device 100 performs wavelength dispersion of the generated fluorescence (step S104). In this instance, a wavelength spectroscopic element, such as a diffraction grating, is used for wavelength dispersion.

Subsequently, the detection section 150 of the electrophoresis device 100 detects the generated fluorescence as a signal charge (step S105). For example, a CCD (Charge Coupled Device) element or a CMOS (Complementary Metal Oxide Semiconductor) element included in the optical detector 156 is used for fluorescence detection. In the present embodiment, it is assumed that the fluorescence is detected by using a CCD element. The CCD element performs detection on the basis of individual dispersed wavelengths. It is assumed, for example, that signals in wavelength regions of 500 to 510 nm, 510 to 520 nm, . . . , 690 to 700 nm are detected by CCD elements corresponding to the respective wavelength regions Further, steps S103 to S105 are chronologically performed an appropriate number of times in accordance with the elapsed time of electrophoresis.

The electrophoresis device 100 adds “1” to the number of detection scans (increments the number of detection scans by 1) (step S106), and returns the processing to step S102.

If, in step S102, the number of detection scans is greater than the maximum number of detections (“NO” at step S102), the electrophoresis device 100 outputs the detected signal charge, as the signal charge data D010, to the electrophoresis data processing device 200 (step S107).

### (Signal Charge Data D010)

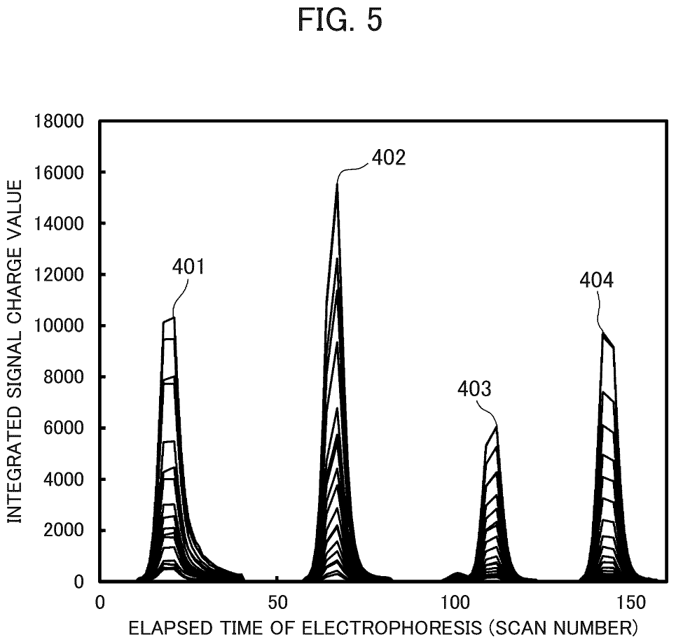

FIG. 5 is a diagram illustrating an example of signal charge data D010. FIG. 1 will be referenced as appropriate.

The signal charge data D010 obtained by allowing the electrophoresis device 100 to perform multiple detections is expressed in a graph depicted, for example, in FIG. 5, with the vertical axis representing the integrated signal charge value and the horizontal axis representing the elapsed time of electrophoresis (the number of scans (Scan Number)). FIG. 5 depicts, for example, the signal charge data D012 of the second sample D002 The signal charge data D011 of the first sample D001 and the signal charge data D013 of the third sample D003 are similar to those in FIG. 5 except that they are expressed by graphs having different shapes.

Each graphed line indicates the wavelength region detected by each CCD element. As described above, each of the CCD elements included in the optical detector 135 depicted in FIGS. 2A and 3A detects the fluorescence of the corresponding wavelength region. That is to say, each graphed line depicted in FIG. 5 corresponds to a respective CCD element. Further, each line depicted in FIG. 5 is obtained by sequentially integrating the signal charge value for each wavelength region.

The signal charge data D010 indicates peaks 401 to 404 corresponding to the respective fluorescent labels with respect to the elapsed time of electrophoresis. For example, peak 401 is derived from the first fluorescent label, and peak 402 is derived from the second fluorescent label. Similarly, peak 403 is derived from the third fluorescent label, and peak 404 is derived from the fourth fluorescent label.

The signal charge data D010 is expressed by the matrix “F” and indicated in Equation (1), where m is the number of wavelength regions and n is the number of performed scans.

$$\begin{matrix}[ Equation 1 ] & \\ F = [ \begin{matrix}{f}_{1 , 1} & … & {f}_{1 , m} \\ ⋮ & ⋱ & ⋮ \\ {f}_{n , 1} & … & {f}_{n , m}\end{matrix} ] & ( 1 )\end{matrix}$$

In the elements fᵢⱼ of the matrix “F” indicated in Equation (1), i represents a wavelength region (CCD element), and j represents the elapsed time of electrophoresis.

The above-mentioned signal charge data D010 is outputted for each of the first sample D001, second sample D002, and third sample D003. More specifically, the signal charge data D011 of the first sample D001, the signal charge data D012 of the second sample D002, and the signal charge data D013 of the third sample D003, which are depicted in FIG. 1, are outputted.

The electrophoresis data processing device 200 uses the signal charge data D010, which is received from the electrophoresis device 100, to eventually output the color signal data DO50 in which the luminance difference between the fluorescent labels has been corrected. Processes performed by the individual sections 201 to 204 of the electrophoresis data processing device 200 are described in detail below.

### <Detailed Description of Color Intensity Adjustment Processing>

### (Processing by Fluorescence Calibration Section 201)

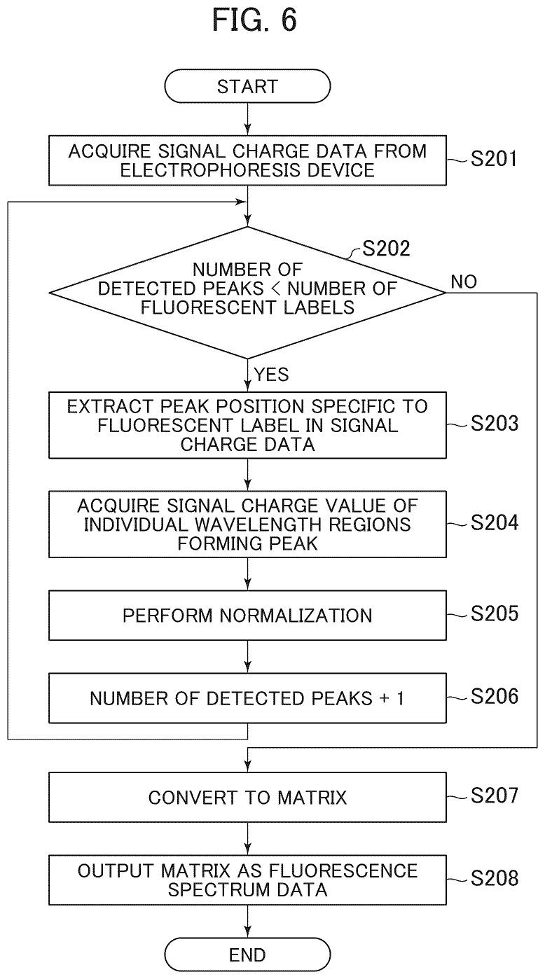

FIG. 6 is a flowchart illustrating processing steps performed by the fluorescence calibration section 201 according to the first embodiment. FIG. 1 will be referenced as appropriate.

The fluorescence calibration section 201 calculates the fluorescence spectrum data D020 in accordance with the flowchart of FIG. 6. Steps S201 to S208 depicted in FIG. 6 are steps for fluorescence spectrum calculation.

First of all, the fluorescence calibration section 201 acquires the signal charge data D010 from the electrophoresis device 100 (step S201). The acquired signal charge data D010 is the signal charge data D012 of the second sample D002, which is adjusted for wavelength calibration.

Further, in step S201, the number of detected peaks is initialized. For example, the value indicating the number of detected peaks is set to “0.” The number of detected peaks is the number of detected peaks 401 to 404 depicted in FIG. 5 (four in the example of FIG. 5). Firstly, when peak 401 depicted in FIG. 5 is detected, the number of detected peaks becomes “1” in step S206. Subsequently, when peak 402 is detected, the number of detected peaks becomes “2” in step S206.

The fluorescence calibration section 201 determines whether the number of detected peaks in the signal charge data D012 is less than the number of fluorescent labels (step S202).

Peak detection is performed, for example, by detecting whether a predetermined threshold is exceeded in the signal charge data D012 or by detecting a point at which the signal charge value changes from an increasing state to a decreasing state. The number of fluorescent labels is the number of fluorescent labels used in the first sample D001, the second sample D002, and the third sample D003. In the present embodiment, the number of fluorescent labels is “4” because the first to fourth fluorescent labels are used. Since the signal charge data D010 handled by the fluorescence calibration section 201 is the signal charge data D010 of the second sample D002, the number of peaks 401 to 404 is equal to the number of fluorescent labels In the signal charge data D011 of the first sample D001 and in the signal charge data D013 of the third sample D003, the number of peaks is not necessarily equal to the number of fluorescent labels.

If the number of detected peaks is equal to or less than the number of fluorescent labels (“YES” at step S202), the fluorescence calibration section 201 extracts peak positions specific to the fluorescent labels from the acquired signal charge data D012 (step S203). The peak positions are extracted as values indicating the elapsed time of electrophoresis corresponding to peaks 401 to 404 depicted in FIG. 5. For example, the peak position of peak 401 in FIG. 5 corresponds to an elapsed time of electrophoresis of approximately “23.”

Subsequently, the fluorescence calibration section 201 acquires the signal charge values of individual wavelength regions forming the peaks (step S204). That is to say, the fluorescence calibration section 201 acquires the values of individual CCD elements at peaks 401 to 404 in FIG. 5.

Subsequently, the fluorescence calibration section 201 normalizes the acquired signal charge values in the individual wavelength regions (S205). For example, the fluorescence calibration section 201 may perform normalization by using the maximum signal charge value in each wavelength region or by using the sum of the signal charge values in the individual wavelength regions.

Subsequently, the fluorescence calibration section 201 adds “1” to the number of detected peaks (increments the number of detected peaks by 1) (step S206), and returns the processing to step S202.

If, in step S202, the number of detected peaks is greater than the number of fluorescent labels (“NO” at step S202), the fluorescence calibration section 201 converts the signal charge values of the respective wavelength regions at the peaks of individual fluorescent labels into a matrix (step S207). In step S207, the fluorescence calibration section 201 converts individual normalized wavelength components into a matrix of the number of fluorescent labels x wavelength information.

Subsequently, the fluorescence calibration section 201 outputs the resulting matrix to the color conversion processing section 202 as the fluorescence spectrum data D020 (step S208). “S,” which indicates the fluorescence spectrum data D020 as the matrix is expressed by Equation (2) below, where the number of wavelength regions is “m” and the number of fluorescent labels is “n.” The meaning of each component in “S” will be described later.

$$\begin{matrix}[ Equation 2 ] & \\ S = [ \begin{matrix}{s}_{1 , 1} & … & {s}_{1 , m} \\ ⋮ & ⋱ & ⋮ \\ {s}_{n , 1} & … & {s}_{n , m}\end{matrix} ] & ( 2 )\end{matrix}$$

### (Fluorescence Spectrum Data D020)

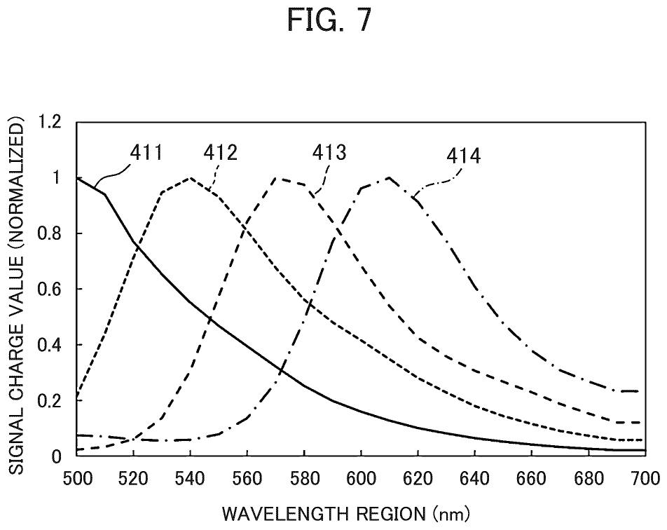

FIG. 7 is a diagram illustrating an example of fluorescence spectrum data D020.

The fluorescence spectrum data D020 created by the fluorescence calibration section 201 is indicated by spectrum 411 to 414 depicted, for example, in FIG. 7 when expressed in a graph with the horizontal axis representing the wavelength region and the vertical axis representing the normalized signal charge value. In FIG. 7, spectrum 411, which is indicated by a solid line, is derived from the first fluorescent label, and spectrum 412, which is indicated by a dashed line, is derived from the second fluorescent label. Spectrum 413, which is indicated by a dashed line, is derived from the third fluorescent label, and spectrum 414, which is indicated by a one-dot chain line, is derived from the fourth fluorescent label.

Incidentally, i in the individual components “Sᵢⱼ” of “S” in Equation (2) corresponds to spectrum 411, spectrum 412, spectrum 413, and spectrum 414 in FIG. 7. j corresponds to the wavelength region in FIG. 7.

The above-mentioned fluorescence spectrum data D020 indicates a wavelength region spectrum that is normalized to “1” for each of peaks 401 to 404 depicted in FIG. 5. For example, spectrum 411 depicted in FIG. 7 indicates a wavelength region spectrum that is normalized to “1” for peak 401 depicted in FIG. 5. Spectrum 412 depicted in FIG. 7 indicates a wavelength region spectrum that is normalized to “1” for peak 402 depicted in FIG. 5. Spectrum 413 depicted in FIG. 7 indicates a wavelength region spectrum that is normalized to “1” for peak 403 depicted in FIG. 5. Spectrum 414 depicted in FIG. 7 indicates a wavelength region spectrum that is normalized to “1” for peak 404 depicted in FIG. 5.

As described above, the fluorescence spectrum data D020 is data that is obtained by normalizing the wavelength spectrum regarding the signal charge value of the fluorescent label used in the second sample D002. The fluorescence calibration section 201 calculates fluorescence spectrum data D020 based on the signal charge data D012 of the second sample D002, and passes the calculated fluorescence spectrum data D020.

Further, it can be said that the fluorescence spectrum data D020 (“S” (Equation (2))), which expresses spectrum 411 to 414 depicted in FIG. 7 by a matrix, is a matrix of weight values indicating the degree of importance of individual wavelength regions for the respective fluorescent labels. For example, spectrum 412 in FIG. 7 indicates that a wavelength region of “540 nm” is important for the second fluorescent label.

### (Processing by Color Conversion Processing Section 202)

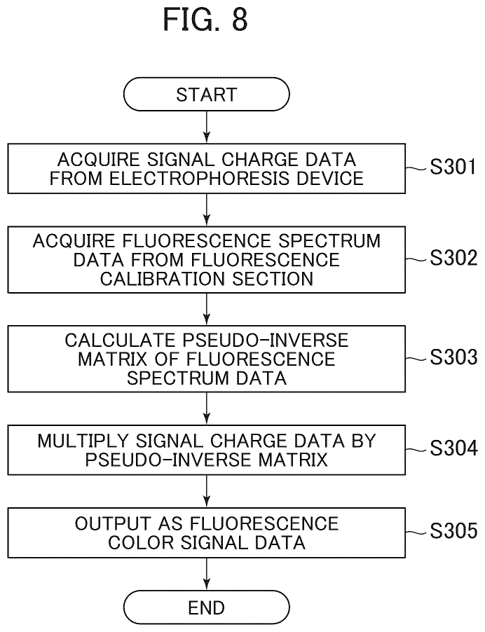

FIG. 8 is a flowchart illustrating processing steps performed by the fluorescence calibration section 201 according to the first embodiment. FIG. 1 will be referenced as appropriate.

The color conversion processing section 202 converts the signal charge data D010 (D011, D013) into the fluorescence color signal data D030 in accordance with the flowchart of FIG. 8. Steps S301 to S305 depicted in FIG. 8 are steps for fluorescence spectrum calculation.

First of all, the color conversion processing section 202 acquires the signal charge data D010 from the electrophoresis device 100 (step S301). In this instance, the acquired signal charge data D010 is the signal charge data D011 of the first sample D001 and the signal charge data D013 of the third sample D003. More specifically, subsequent steps S302 to S305 are performed on the signal charge data D011 of the first sample D001 and on the signal charge data D013 of the third sample D003.

Subsequently, the color conversion processing section 202 acquires the fluorescence spectrum data D020 from the fluorescence calibration section 201 (step S302).

Next, the color conversion processing section 202 calculates a pseudo-inverse matrix of the acquired fluorescence spectrum data D020 (step S303).

Further, the color conversion processing section 202 multiplies the signal charge data D010 (each of the signal charge data D011 and D013), which is acquired in step S601, by the pseudo-inverse matrix calculated in step S303 (step S304).

Finally, the color conversion processing section 202 outputs the result of calculation performed in step S304, as the fluorescence color signal data D030, to the intensity correction coefficient determination section 203 and to the intensity adjustment processing section 204 (step S305). In step S305, the color conversion processing section 202 outputs the fluorescence color signal data D031 of the first sample D001 to the intensity adjustment processing section 204. Then, in step S305, the color conversion processing section 202 outputs the fluorescence color signal data D033 of the third sample D003 to the intensity correction coefficient determination section 203.

The fluorescence color signal data D030 is actually outputted in the form of a matrix. When the number of fluorescent labels is “n” and the number of performed scans is “m,” a matrix “C” representing the fluorescence color signal data D030 is expressed by Equation (3) below.

$$\begin{matrix}[ Equation 3 ] & \\ C = [ \begin{matrix}{c}_{1 , 1} & … & {c}_{1 , m} \\ ⋮ & ⋱ & ⋮ \\ {c}_{n , 1} & … & {c}_{n , m}\end{matrix} ] & ( 3 )\end{matrix}$$

When calculating the fluorescence color signal data D030, the color conversion processing section 202 uses the signal charge data D010 “F,” the pseudo-inverse matrix “S⁻¹” of the fluorescence spectrum data D020, and the matrix “C” of the fluorescence color signal data D030 as indicated in Equations (11) to (13) below. The processing performed in step S304 of FIG. 8 is the calculation indicated in Equation (13).

$$F = CS \qquad ( 11 )$$

$$F {S}^{- 1} = C S {S}^{- 1} \qquad ( 12 )$$

$$F {S}^{- 1} = C \qquad ( 13 )$$

More specifically, the color conversion processing section 202 uses Equation (13) to calculate the fluorescence color signal data D030 as the matrix “C.” As described above, the color conversion processing section 202 calculates the fluorescence color signal data D033 of the third sample D003 by multiplying the signal charge data D013 of the third sample D003 by the pseudo-inverse matrix of the fluorescence spectrum data D020. Similarly, the color conversion processing section 202 calculates the fluorescence color signal data D031 of the first sample D001 by multiplying the signal charge data D011 of the first sample D001 by the pseudo-inverse matrix of the fluorescence spectrum data D020.

### (Fluorescence Color Signal Data D030)

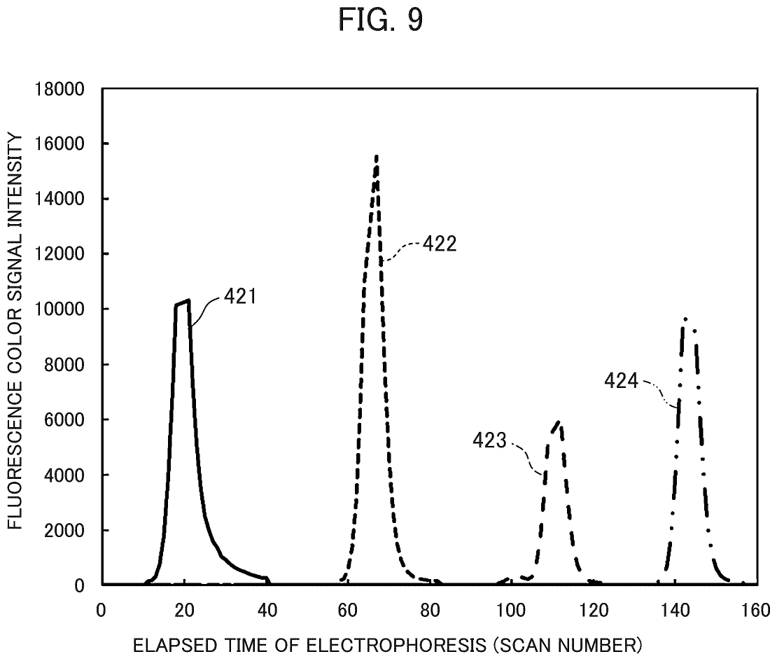

FIG. 9 is a diagram illustrating an example of fluorescence color signal data 30. FIG. 9 depicts the fluorescence color signal data D033 that is generated based on the signal charge data D013 of the third sample D003. The fluorescence color signal data D033 of the first sample D001 is data similar to that depicted in FIG. 9 except that they are expressed by graphs having different shapes.

When the matrix “C” of the fluorescence color signal data D030 calculated by the color conversion processing section 202 is graphed, it is expressed by graphs 421 to 424 depicted in FIG. 9 with the horizontal axis representing the elapsed time of electrophoresis (number of scans performed (Scan Number)) and the vertical axis representing the fluorescence color signal intensity. In FIG. 9, graph 421, which is indicated by a solid line, is derived from the first fluorescent label, and graph 422, which is indicated by a dashed line, is derived from the second fluorescent label. Further, graph 423, which is indicated by a dashed line, is derived from the third fluorescent label, and graph 424, which is indicated by a two-dot chain line, is derived from the fourth fluorescent label.

As regards the component “Cᵢⱼ” of “C” of the fluorescence color signal data D030 indicated in Equation (3), i corresponds to graphs 421, 422, 423, and 424, respectively. Meanwhile, j corresponds to the horizontal axis of FIG. 9 (the elapsed time of electrophoresis).

As indicated in FIG. 9, the fluorescence color signal data D030 is such that information regarding the wavelength regions is removed from graphs 421 to 424 depicted in FIG. 5 so as to present information regarding the signal intensity (fluorescence color signal intensity) of each fluorescent label. The fluorescence color signal data D030 calculated in the above manner is chronological information regarding the signal intensity of each fluorescent label. Then, the color conversion processing section 202 calculates fluorescence color signal data (second fluorescence color signal data) D033 (D030) of the third sample D003 in accordance with the signal charge data D013 of the third sample D003 and with a fluorescence spectrum matrix. The fluorescence color signal data D033, which will be described later, is chronological information regarding the signal intensity of each fluorescent label. Additionally, the color conversion processing section 202 calculates fluorescence color signal data (third fluorescence color signal data) D031 (D030) of the first sample D001 in accordance with the signal charge data D011 of the first sample D001 and with a fluorescence spectrum matrix.

### (Processing by Intensity Correction Coefficient Determination Section 203)

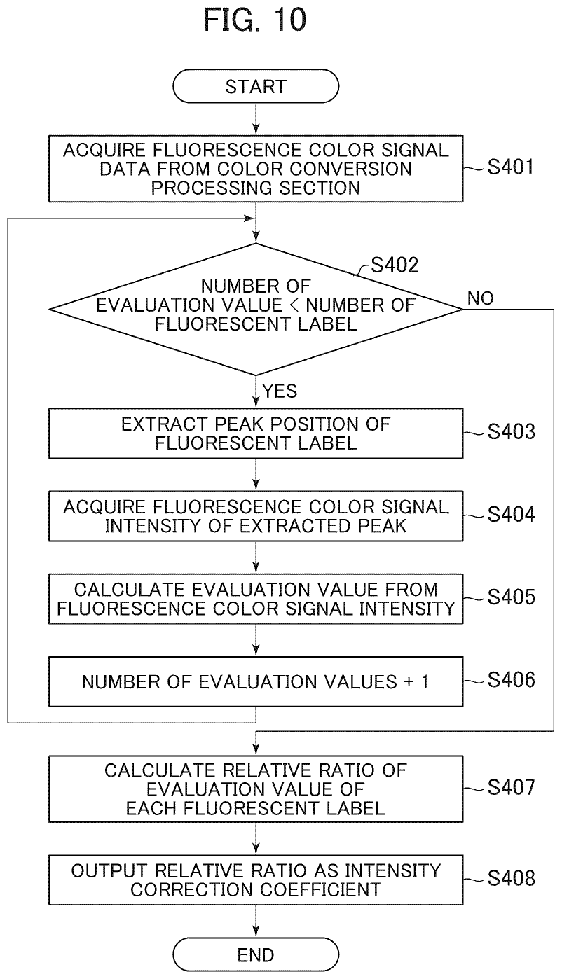

FIG. 10 is a flowchart illustrating processing steps performed by the intensity correction coefficient determination section 203 according to the first embodiment. FIG. 1 will be referenced as appropriate.

The intensity correction coefficient determination section 203 calculates the intensity correction coefficient D040 in accordance with the flowchart of FIG. 10. Steps S401 to S408 in FIG. 10 are intensity correction coefficient calculation steps.

First of all, the intensity correction coefficient determination section 203 acquires the fluorescence color signal data D030 from the color conversion processing section 202 (step S401). The fluorescence color signal data D030 used in this instance is the fluorescence color signal data D033 obtained by subjecting the signal charge data D013 of the third sample D003, which is the sample for intensity correction coefficient determination, to color conversion by the color conversion processing section 202. In this instance, the number of evaluation values is initialized, for example, to “0.”

Next, the intensity correction coefficient determination section 203 determines whether the number of evaluation values is less than the number of fluorescent labels (step S402). The number of evaluation values corresponds to the number of rows of the matrix “C,” which represents the fluorescence color signal data D030 indicated in Equation (3). For example, in a case where the first row of the matrix “C” has been processed, the number of evaluation values becomes “1” in step S406. Similarly, in a case where the second row of the matrix “C” has been processed, the number of evaluation values becomes “2” in step S406. In the above-described manner, the intensity correction coefficient determination section 203 performs steps S403 to S406 for each row of the matrix “C” indicated in Equation (3). As described above, the number of fluorescent labels is the number of fluorescent labels used, and is “4” in the example indicated in conjunction with the present embodiment.

If the number of evaluation values is less than the number of fluorescent labels (“YES” at step S402), the intensity correction coefficient determination section 203 uses the acquired fluorescence color signal data D033 to extract the peak positions regarding the fluorescent labels targeted for processing (step S403).

Next, the intensity correction coefficient determination section 203 acquires the fluorescence color signal intensity of the peaks (peak positions) extracted in step S403 (step S404). The peak positions represent the elapsed time corresponding to the highest fluorescence color signal intensity in each of graphs 421 to 424 in the example of FIG. 9.

Subsequently, the intensity correction coefficient determination section 203 calculates the evaluation values from the information regarding the fluorescence color signal intensity acquired in step S404 (step S405). The evaluation values will be described later.

Further, the intensity correction coefficient determination section 203 adds “1” to the number of evaluation values (increments the number of evaluation values by 1) (step S406), and returns the processing to step S402.

If, in step S402, the number of evaluation values is equal to or greater than the number of fluorescent labels (“NO” at step S402), the intensity correction coefficient determination section 203 calculates the relative ratio of the evaluation value of each fluorescent label (step S407). The relative ratio will be described later.

Subsequently, the intensity correction coefficient determination section 203 outputs the relative ratio, which is calculated in step S407, to the intensity adjustment processing section 204 as the intensity correction coefficient D040 (step S408).

The average value of the fluorescence color signal intensities of the peaks acquired in step S404 is used as the evaluation value calculated in step S405. That is to say, the intensity adjustment processing section 204 calculates the evaluation value for each fluorescent label by calculating the average value of the peaks derived from each fluorescent label in the fluorescence color signal data D033 of the third sample D003.

FIG. 11 is another diagram illustrating an example of fluorescence color signal data D030.

FIG. 9 depicts an example in which one peak is detected for each fluorescent label. Meanwhile, FIG. 11 depicts an example in which two peaks are detected for each fluorescent label. More specifically, peaks 421a and 421b are peaks corresponding to the first fluorescent label, and peaks 422a and 422b are peaks corresponding to the second fluorescent label. Similarly, peaks 423a and 423b are peaks corresponding to the third fluorescent label, and peaks 424a and 424b are peaks corresponding to the fourth fluorescent label.

For example, in a case where the evaluation values are to be obtained from the fluorescence color signals depicted in FIG. 11, the evaluation value “C1” of the first fluorescent label is the average value of the fluorescence color signal intensities of peaks 421a and 421b. Further, in a case where X peaks of the first fluorescent label are obtained, the average value of the X peaks becomes the evaluation value “C1.” As regards the evaluation values of the second to fourth fluorescent labels, the intensity correction coefficient determination section 203 calculates evaluation values “C2” to “C4” in the same manner as for “C1.”

Further, the relative ratio calculated in step S407 is the ratio of the evaluation value of each fluorescent label to the evaluation value of one fluorescent label that is regarded as a reference. For example, if the reference is “C1” (reference signal intensity; reference evaluation value) in a case where evaluation values “C1” to “C4” are used, the relative ratio of the first fluorescent label is expressed as “C1/C1,”, and the relative ratio of the second fluorescent label is expressed as “C1/C2” (the ratio between each fluorescent label and the reference signal intensity). Specifically, the intensity correction coefficient determination section 203 selects an appropriate evaluation value from among the calculated evaluation values, sets the selected appropriate evaluation value as a reference evaluation value, and calculates the intensity correction coefficient D040 for each fluorescent label by dividing the reference evaluation value by each evaluation value.

As described above, the intensity correction coefficient D040 is the ratio between the signal intensity of each fluorescent label and the reference signal intensity (fluorescence color signal intensity) of a specific fluorescent label in the fluorescence color signal data D031 of the third sample D003.

### (Processing by Intensity Adjustment Processing Section 204)

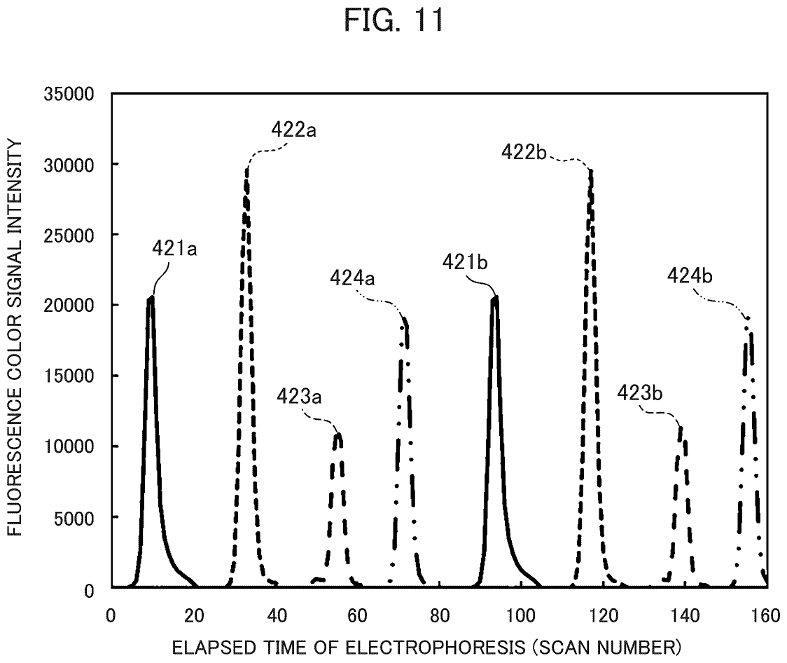

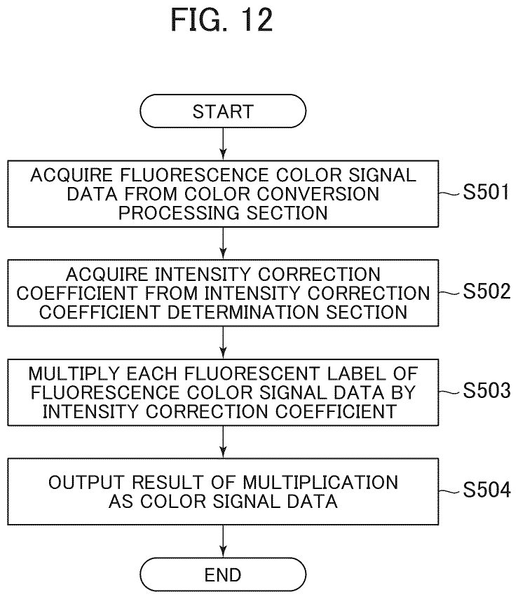

FIG. 12 is a flowchart illustrating processing steps performed by the intensity adjustment processing section 204 according to the first embodiment.

In accordance with the flowchart of FIG. 12, the intensity adjustment processing section 204 adjusts the fluorescence color signal data D031 for the color signal data D050 that is appropriate for secondary analysis. Steps S501 to S503 in FIG. 12 are color signal data calculation steps, and step S504 is an output step.

First of all, the intensity adjustment processing section 204 acquires the fluorescence color signal data D031 of the first sample D001 from the color conversion processing section 202 (step S501).

Next, the intensity adjustment processing section 204 acquires the intensity correction coefficient D040 from the intensity correction coefficient determination section 203 (step S502).

Subsequently, the intensity adjustment processing section 204 multiplies each fluorescent label of the acquired fluorescence color signal data D031 by the intensity correction coefficient D040 (step S503). The intensity adjustment processing section 204 multiplies each piece of fluorescent label data in the fluorescence color signal data D031 by the corresponding intensity correction coefficient D040. In the above-described manner, the intensity adjustment processing section 204 calculates the color signal data D050.

Finally, the intensity adjustment processing section 204 outputs the result of multiplication in step S503 to the display device 301 as the color signal data D050 (step S504).

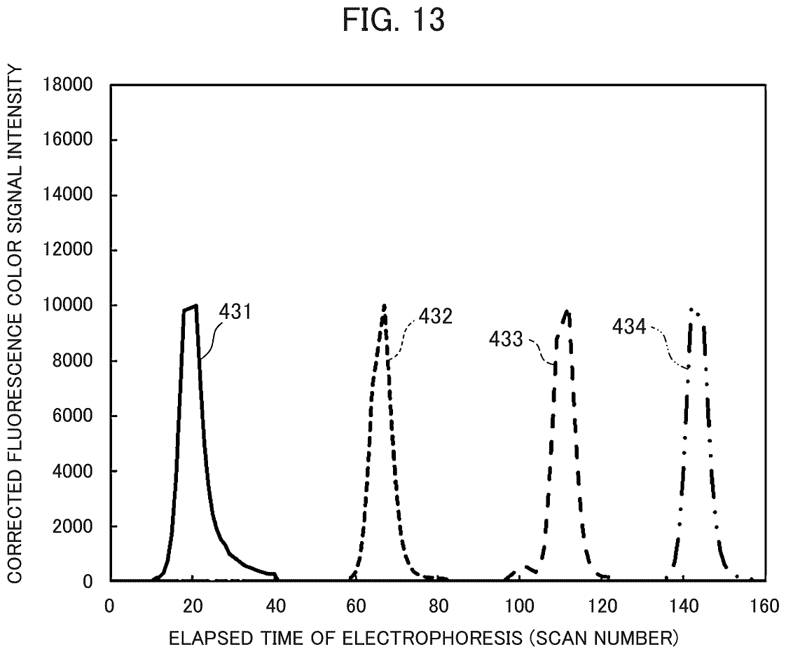

FIG. 13 is a diagram illustrating an example of color signal data D050. FIG. 13 depicts an example in which the intensity correction coefficient D040 is applied to the fluorescence color signal data D030 of the first sample D001.

The color signal data DO50 outputted by the intensity adjustment processing section 204 is represented by graphs 431 to 434, which are depicted, for example, in FIG. 13, with the horizontal axis representing the elapsed time of electrophoresis (number of detection scans (Scan Number)) and the vertical axis representing the corrected fluorescence color signal intensity. As is the case with FIG. 9, FIG. 13 depicts an example in which one peak is detected from one fluorescent label. Graph 431, which is indicated by a solid line, is derived from the first fluorescent label, and graph 432, which is indicated by a dashed line, is derived from the second fluorescent label. Similarly, graph 433, which is indicated by a dashed line, is derived from the third fluorescent label, and graph 434, which is indicated by a two-dot chain line, is derived from the fourth fluorescent label.

As illustrated in FIG. 13, the fluorescence color signal intensities of the fluorescent labels are adjusted to be uniform.

### <Independence of Determination of Intensity Correction Coefficient D040>

In some cases, the electrophoresis device 100 may perform fluorescence detection by using the same light source 114 (see FIG. 2A) for a plurality of capillaries 102. In such cases, the processing by the intensity correction coefficient determination section 203 and the processing by the intensity adjustment processing section 204 are performed independently for each capillary 102 in accordance with the first embodiment.

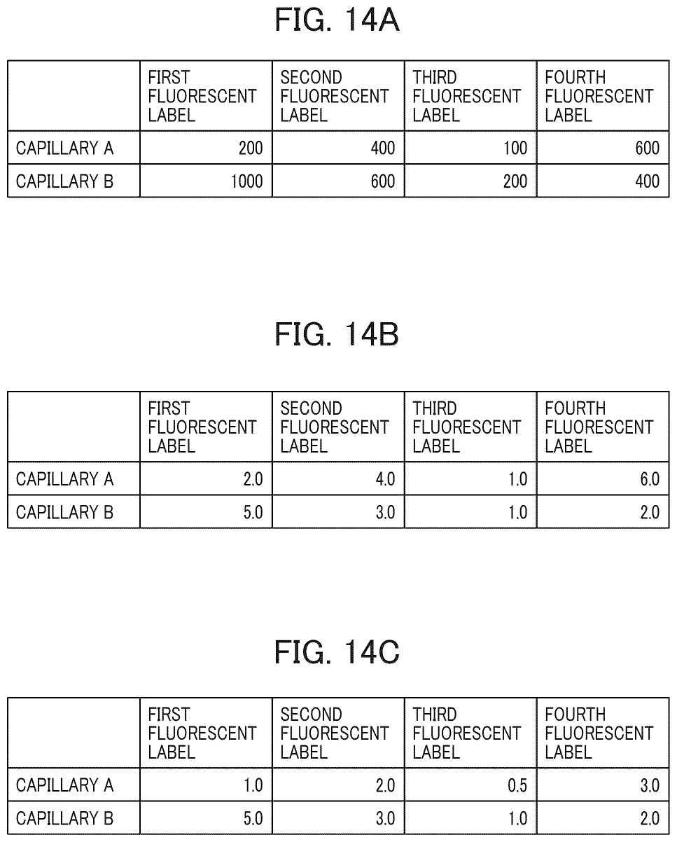

FIG. 14A is a table illustrating examples of evaluation values for individual capillaries 102 and individual fluorescent labels. FIG. 14B and FIG. 14B are tables illustrating examples of the intensity correction coefficient D040 calculated based on the evaluation values as indicated in FIG. 14A.

“Capillary A” and “Capillary B,” which are indicated in FIGS. 14A to 14C, are different capillaries 102.

The following describes a case where the evaluation values for the individual fluorescent labels in the fluorescence color signal data D033 of the third sample D003 are as indicated in FIG. 14A. When the third fluorescent label is used as a reference for all capillaries 102, the intensity correction coefficient D040 is expressed as indicated in FIG. 14B. In FIG. 14B, the intensity correction coefficient D040 is calculated by using the third fluorescent label as the reference for both “Capillary A” and “Capillary B.” However, as indicated in FIG. 14B, all of the capillaries 102 need not be based on the same reference fluorescent label. For example, in a case where the evaluation values such as those indicated in FIG. 14A are obtained, the intensity correction coefficient D040 may be determined based on the first fluorescent label for “Capillary A” and based on the third fluorescent label for “Capillary B.” In such a case, the intensity correction coefficient D040 is expressed by values indicated in FIG. 14C.

As described above, it is possible to appropriately determine which fluorescent label to use as the reference in the case of calculation of the intensity correction coefficient D040. Further, the calculation of the color signal data DO50 through the use of the intensity correction coefficient D004 is also performed for each capillary 102.

As described above, the processing by the intensity correction coefficient determination section 203 and the processing by the intensity adjustment processing section 204 are performed independently in each capillary 102. Consequently, the result derived from the second sample D002 and the result derived from the third sample D003 do not affect each other even if the second sample D002 and the third sample D003 differ from each other or use different fluorescent labels.

### <Screen Example>

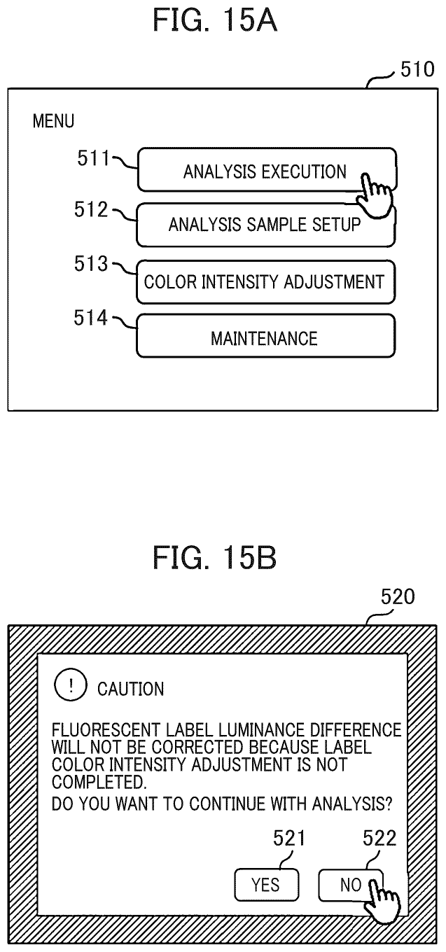

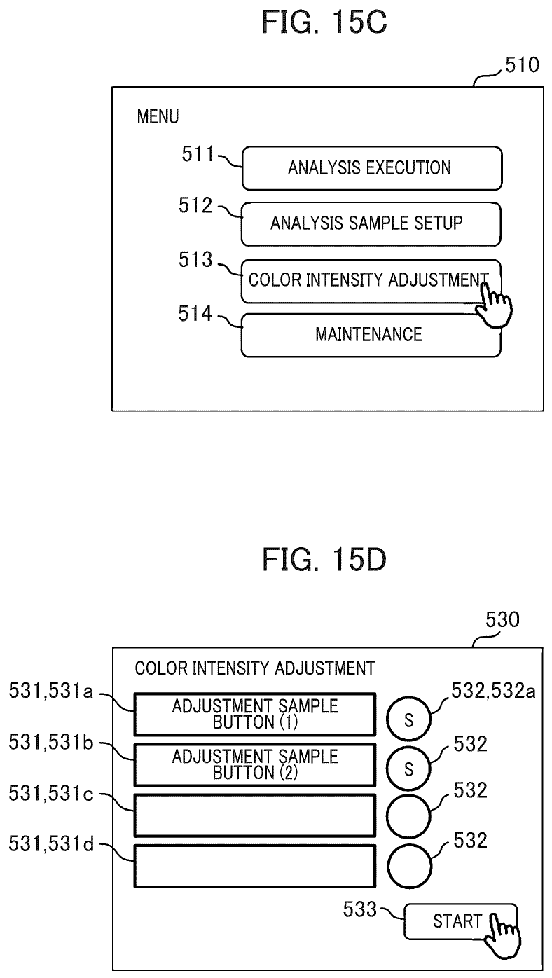

Examples of screen transitions in the present embodiment will now be described with reference to FIGS. 15A to 15D.

FIG. 15A is a diagram illustrating an example of a menu screen 510, and FIG. 15B is a diagram illustrating an example of an alert screen 520. FIG. 15C is a diagram illustrating an example of a menu screen 510, and FIG. 15D is a diagram illustrating an example of a color intensity adjustment screen 530.

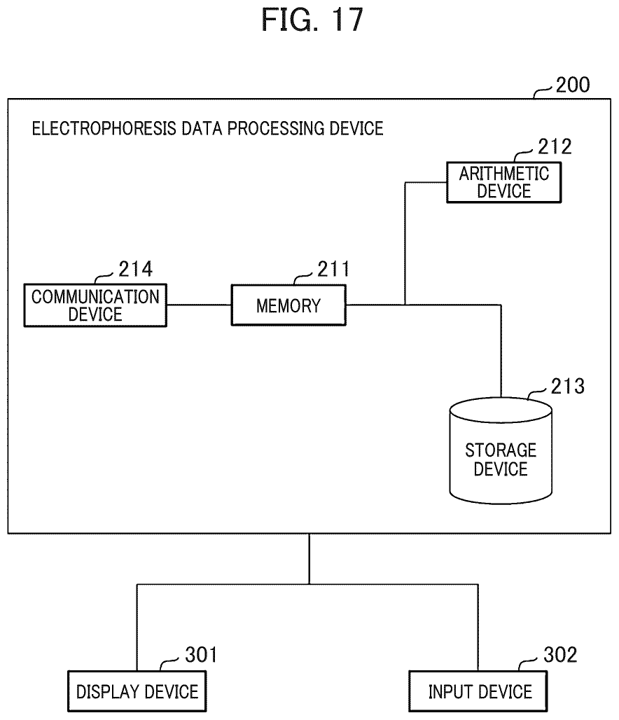

The menu screen 510 has a button for performing an intensity adjustment function in addition to a button for performing an analysis execution function. More specifically, as depicted in FIG. 15A, an analysis execution button 511, an analysis sample setup button 512, a color intensity adjustment button 513, and a maintenance button 514 are displayed. When the user performs a selective input by pressing the analysis execution button 511, for example, the base sequence information regarding the DNA molecules is analyzed. That is to say, an analysis is performed on the signal charge data D011 of the first sample D001, which is a real sample. The selective input is performed through the input device 302 depicted in FIG. 17. When the user performs a selective input by pressing the analysis sample setup button 512, a setup screen regarding, for example, the first sample D001 in which a plurality of fluorescent labels are attached to DNA molecules is displayed. When the user performs a selective input by pressing the color intensity adjustment button 513, the color intensity adjustment screen 530 (see FIG. 15D) for executing the color intensity adjustment process described in conjunction with the present embodiment is displayed. When the user performs a selective input by pressing the maintenance button 514, a maintenance execution screen (not depicted) for the electrophoresis device 100 is displayed.

If the user performs a selective input by pressing the analysis execution button 511 in a state where the color intensity adjustment process is incomplete, the fluorescence color signal data D030 in which the fluorescent labels vary in intensity as depicted in FIG. 9 is acquired. Therefore, when the analysis execution button 511 is pressed to perform a selective input in a state where the color intensity adjustment process is incomplete, the present embodiment displays the alert screen 520 as indicated in FIG. 15B before actual analysis execution. The alert screen 520 presents a dialogue (warning information) for drawing attention to the fact that color intensity adjustment has not been made. Stated differently, if an attempt is made to analyze the signal charge data D011 in a state where the intensity correction coefficient D040 is not calculated, the warning information is outputted to the display device 301 in order to indicate that the intensity correction coefficient D040 is not calculated.

When the alert screen 520 appears on display, the user is able to recognize the presence of the color intensity adjustment process. Further, as depicted in FIG. 15B, the alert screen 520 displays a YES button 521 and a NO button 522. If the user performs a selective input by pressing the NO button 522, an analysis is executed without performing the color intensity adjustment process. Meanwhile, if the user performs a selective input by pressing the YES button 521, the screen transitions to the menu screen 510 as indicated in FIG. 15C.

As indicated in FIG. 15C, when the user performs a selective input by pressing the color intensity adjustment button 513, the screen transitions to the color intensity adjustment screen 530 depicted in FIG. 15D. The color intensity adjustment screen 530 displays adjustment sample buttons 531a to 531d. Each of the adjustment sample buttons 531a to 531d corresponds to a capillary 102. That is to say, FIG. 15D depicts an example in which the electrophoresis device 100 has four capillaries 102. When the user performs a selective input by pressing one of the adjustment sample buttons 531a to 531d, information regarding the adjustment sample to be disposed in each capillary 102 can be set. The adjustment sample is a sample for determining the intensity correction coefficient D040, and is the third sample D003 in the first embodiment. In the example depicted in FIG. 15C, the adjustment sample buttons 531c, 531d are blank. This indicates that adjustment samples are set in the capillaries 102 corresponding to the adjustment sample buttons 531a, 531b, and that no adjustment samples are set in the capillaries 102 corresponding to the adjustment sample buttons 531c, 531d. Further, a start button 533 is displayed on the color intensity adjustment screen 530. When the user performs a selective input by pressing the start button 533 after the adjustment samples are set in the respective capillaries 102 to be used, the color intensity adjustment process starts. In this case, the color intensity adjustment process is performed collectively for all of the capillaries 102 in which the adjustment samples are set.

Further, on the color intensity adjustment screen 530, individual start buttons 532 are displayed in a form corresponding to the respective adjustment sample buttons 531. When the user performs a selective input by pressing an individual start button 532, the color intensity adjustment process for the corresponding capillary 102 starts. For example, when the user performs a selective input by pressing the individual start button 532a, the color intensity adjustment process starts for the capillary 102 corresponding to the adjustment sample button 531a, and the color intensity adjustment process will not be performed for the other capillaries 102.

When the start button 533 is pressed after an adjustment sample is set in the electrophoresis device 100 in the above manner, the intensity correction coefficient D040 is calculated.

In the present embodiment, the alert screen 520 prompts the user to recognize the presence of the color intensity adjustment process. However, the presence or absence of the color intensity adjustment process may be clearly indicated in a document such as an instruction manual.

It is preferable that each of the screens 510, 520, 530 depicted in FIGS. 15A to 15D be displayed separately from a DNA analysis screen.

Data of the DNA sample (first sample D001) derived from electrophoresis needs to be acquired in such a manner that all the colors match. Until now, it has been necessary to adjust the parameters for binning prior to measurement, which has been one of the factors that makes it difficult to use new reagents in the electrophoresis device 100. According to the present embodiment, using an existing third sample D003, such as the allelic ladder, makes it possible to suppress the variation in the fluorescence color signal intensity of the first sample D001 without relying on binning. Further, the fluorescence color signal intensities of the fluorescent labels can be made uniform so as not to exceed the maximum allowable intensity of the CCD elements of the optical detector 156. As described above, the first embodiment provides a technology for calculating an effective intensity correction coefficient D040 accurately and as quickly as possible for a set of employed fluorescent labels and applying the calculated intensity correction coefficient D040 to an analysis target, thereby making it possible to suppress the variation in the sensitivity of the fluorescent labels. Therefore, efficient analysis of electrophoresis results can be supported.

Furthermore, using the allelic ladder as the third sample D003 makes it possible to use the allelic ladder, which evaluates the DNA molecule length of the first sample D001, for calculating the intensity correction coefficient D040.

### Second Embodiment

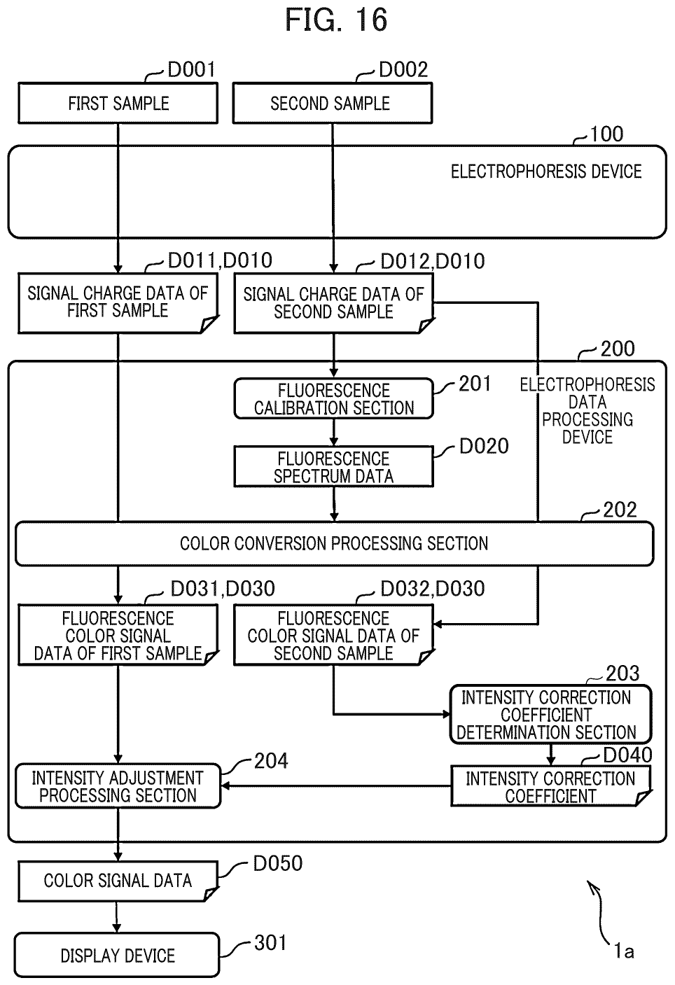

FIG. 16 is a diagram illustrating an example of the configuration of an electrophoresis device 1a in the second embodiment.

In the second embodiment, the intensity correction coefficient D040 is calculated based on the second sample D002 although the intensity correction coefficient D040 is calculated based on the third sample D003 in the first embodiment.

In the electrophoresis system 1a, the first sample D001 and the second sample (first reference sample and second reference sample) D002, which are different from each other, are used to finally output the color signal data DO50 of the first sample D001. Further, it is assumed that the same type of fluorescent label is attached to the first sample D001 and the second sample D002.

The second embodiment is configured such that the signal charge data D012 (D010) obtained from the second sample D002, which is used to calculate the fluorescence spectrum data D020, is inputted to the color conversion processing section 202 as second signal data, and that fluorescence color signal data D032 (D030) of the second sample D002 is outputted. As the second sample D002, the matrix standard is used as described above. Then, based on the outputted fluorescence color signal data D032 of the second sample D002, the intensity correction coefficient determination section 203 calculates the intensity correction coefficient D040.

In addition to adjusting the fluorescence color signal intensity, it has been necessary to use the matrix standard, which is a fluorescence calibration reagent for suppressing the generation of false fluorescence signals. The matrix standard has been originally used only for suppressing the false signals. However, when the inventors paid attention to the intensity ratio, they found that the intensity ratio between signals obtained from the DNA and signals obtained from the matrix standard remained constant. In the second embodiment, the above-mentioned calibration reagent is also used for intensity correction so that all the colors match.

The second embodiment makes it possible to use a smaller number of samples than the first embodiment by calculating the intensity correction coefficient D040 from the second sample D002, such as the matrix standard, without using the third sample D003.

Until now, the matrix standard has been used to adjust wavelength and frequency directions as described, for example, in International Publication No. WO 2014/188887, and has not been used to adjust the fluorescence color signal intensity. Similarly, the allelic ladder, which is used as the third sample D003 in the first embodiment, is a reference sample for allowing the user to recognize the length of the DNA molecules in the first sample D001, and has not been used to correct the fluorescence color signal intensity. The present embodiment is characterized in that the variation in the fluorescence color signal intensity is adjusted by using, for example, the allelic ladder or the matrix standard.

In the present embodiment, the fluorescence color signal data D032, D033 calculated from the second sample D002, such as the matrix standard, and the third sample D003, such as the allelic ladder, are used for calculating the intensity correction coefficient D040. Alternatively, however, the reference sample for evaluating and calibrating the data derived from the first sample D001, which is a real sample, may be used to calculate the intensity correction coefficient D040.

Specifically, the reference sample is usable when it has characteristics (A1) and (A2), which are described below.
(A1) The fluorescent label used for electrophoresis of the DNA sample and the fluorescent label used for calibration are of the same type.
(A2) The fluorescence intensity ratios between the fluorescent labels regarding the fluorescence color signal intensities obtained by color-converting the fluorescence from the fluorescent labels have a similar correlation (e.g., correlation coefficient R>0.8).

### [Hardware Configuration]

FIG. 17 is a diagram illustrating an example of the hardware configuration of an electrophoresis data processing device 200.

The electrophoresis data processing device 200 includes a memory 211 such as a RAM (Random Access Memory), an arithmetic device 212, a storage device 213, and a communication device 214. The arithmetic device 212 includes, for example, a CPU (Central Processing Unit) and a GPU (Graphics Processing Unit). The storage device 213 includes, for example, HDD (Hard Disk Drive) and SDD (Solid State Drive). The communication device 214 transmits and receives data to and from the electrophoresis device 100 (see FIGS. 1 and 16). Further, the electrophoresis data processing device 200 is connected to the display device 301, such as a display, and the input device 302 formed, for example, by a keyboard and a mouse.

A program stored in the storage device 213 is loaded into the memory 211, and the loaded program is executed by the arithmetic device 212. This results in materializing the fluorescence calibration section 201, the color conversion processing section 202, the intensity correction coefficient determination section 203, and the intensity adjustment processing section 204, which are depicted in FIGS. 1 and 17.

It is assumed that the function of the intensity correction coefficient determination section 203 is executed separately and independently from the function of performing a DNA analysis.

It should be noted that the present disclosure is not limited to the embodiments described above, and includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

Further, for example, the above-described component elements, functions, sections 201 to 204, and storage device 213 may be implemented by hardware by designing some or all of them, for instance, as an integrated circuit. Furthermore, as depicted in FIG. 17, for example, the above-described component elements and functions may be implemented by software by allowing the arithmetic device 212, such as a CPU, to interpret and execute programs that implement their functions. As depicted in FIG. 17, programs, tables, files, and other information implementing the individual functions can be stored not only on a HD but also in the memory 211, a recording device such as an SSD, or a recording medium such as an IC (Integrated Circuit) card, an SD (Secure Digital) card, or a DVD (Digital Versatile Disc).

Moreover, control lines and information lines depicted in conjunction with the foregoing embodiments are considered necessary for explanation. It should be noted that all the control lines and information lines related to products are not necessarily depicted. In reality, almost all the component elements can be considered interconnected.

### LIST OF REFERENCE SIGNS

1: electrophoresis system
1a: electrophoresis system
100: electrophoresis device
102: capillary
150: detection section
200: electrophoresis data processing device
201: fluorescence calibration section (fluorescence spectrum calculation section)
202: color conversion processing section (fluorescence color signal data calculation section)
203: intensity correction coefficient determination section (intensity correction coefficient calculation section)
204: intensity adjustment processing section (color signal data calculation section)
301: display device (output section)
510: menu screen
511: analysis execution button
512: analysis sample setup button
513: color intensity adjustment button
520: alert screen (display warning information)
530: color intensity adjustment screen
531: adjustment sample button
531a: adjustment sample button
531b: adjustment sample button
531c: adjustment sample button
531d: adjustment sample button
D001: first sample (real sample and fluorescent label are included)
D002: second sample (first standard sample and fluorescent label are included)
D003: third sample (second standard sample and fluorescent label are included)
D010: signal charge data
D011: signal charge data (third signal charge data)
D012: signal charge data (first signal charge data, second signal charge data)
D013: signal charge data (second signal charge data)
D020: fluorescence spectrum data
D030: fluorescence color signal data
D031: fluorescence color signal data (third fluorescence color signal data)
D033: fluorescence color signal data (second fluorescence color signal data)
D040: intensity correction coefficient
D050: color signal data
S201 to S208: fluorescence spectrum calculation
S301 to S305: fluorescence spectrum calculation
S401 to S408: intensity correction coefficient calculation step
S501 to S503: color signal data calculation step
S504: output step

1. An electrophoresis data processing device comprising:
a fluorescence spectrum calculation section that, based on first signal charge data indicating the result of electrophoresis of a first reference sample for calibrating data derived from a real sample, calculates fluorescence spectrum data, namely, the data obtained by normalizing a wavelength spectrum regarding signal charge values of fluorescent labels used for the first reference sample;
a fluorescence color signal data calculation section that calculates second fluorescence color signal data in accordance with the fluorescence spectrum data and with second signal charge data, the second signal charge data indicating the result of the electrophoresis of a second reference sample for evaluating or calibrating data derived from the real sample, the second fluorescence color signal data being chronological information regarding the signal intensity of each of the fluorescent labels, and calculates third fluorescence color signal data representing chronological information regarding the signal intensity of each of the fluorescent labels in accordance with the fluorescence spectrum data and with third signal charge data indicating the result of the electrophoresis of the real sample:
an intensity correction coefficient calculation section that calculates, in the second fluorescence color signal data, an intensity correction coefficient indicating the ratio between the signal intensity of each of the fluorescent labels and a predetermined reference signal intensity of the fluorescent labels:
a color signal data calculation section that calculates color signal data by multiplying each data of the fluorescent labels of the third fluorescence color signal data by the corresponding intensity correction coefficient; and
an output section that outputs the color signal data.

2. The electrophoresis data processing device according to claim 1,
wherein the fluorescence color signal data calculation section
calculates the second fluorescence color signal data by multiplying the second signal charge data indicating the result of the electrophoresis of the second reference sample, by a pseudo-inverse matrix of the fluorescence spectrum data, and
calculates the third fluorescence color signal data by multiplying the third signal charge data by the pseudo-inverse matrix of the fluorescence spectrum data.

3. The electrophoresis data processing device according to claim 1,
wherein the intensity correction coefficient calculation section calculates, in the second fluorescence color signal data, the average value of peaks derived from each of the fluorescent labels in order to calculate evaluation values of the fluorescent labels, selects an appropriate evaluation value from the calculated evaluation values as a reference evaluation value, and divides the reference evaluation value by each of the evaluation values to calculate the intensity correction coefficient for each of the fluorescent labels.

4. The electrophoresis data processing device according to claim 1,
wherein the first reference sample is a matrix standard; and
wherein the second reference sample is an allelic ladder.

5. The electrophoresis data processing device according to claim 1,
wherein each of the first and second reference samples is a matrix standard.

6. The electrophoresis data processing device according to claim 1,
wherein an electrophoresis device configured to perform electrophoresis includes the first reference sample, the second reference sample, and a plurality of capillaries that distribute the real sample; and
wherein processes performed by the fluorescence spectrum calculation section, the fluorescence color signal data calculation section, the intensity correction coefficient calculation section, and the color signal data calculation section are performed independently for each of the capillaries.

7. The electrophoresis data processing device according to claim 1,
wherein, if an attempt is made to analyze the third signal charge data in a state where the intensity correction coefficient is not calculated, the output section outputs warning information to indicate that the intensity correction coefficient is not calculated.

8. An electrophoresis data processing method that is used by an electrophoresis data processing device, the electrophoresis data processing method comprising:
a fluorescence spectrum calculation step of, based on first signal charge data indicating the result of electrophoresis of a first reference sample for calibrating data derived from a real sample, calculating fluorescence spectrum data, namely, the data obtained by normalizing a wavelength spectrum regarding signal charge values of fluorescent labels used for the first reference sample;
a fluorescence color signal data calculation step of calculating second fluorescence color signal data in accordance with the fluorescence spectrum data and with second signal charge data, the second signal charge data indicating the result of the electrophoresis of a second reference sample for evaluating or calibrating the data derived from the real sample, the second fluorescence color signal data being chronological information regarding the signal intensity of each of the fluorescent labels, and calculating third fluorescence color signal data representing chronological information regarding the signal intensity of each of the fluorescent labels in accordance with the fluorescence spectrum data and with third signal charge data indicating the result of the electrophoresis of the real sample;
an intensity correction coefficient calculation step of calculating, in the second fluorescence color signal data, an intensity correction coefficient indicating the ratio between the signal intensity of each of the fluorescent labels and a predetermined reference signal intensity of the fluorescent labels;
a color signal data calculation step of calculating color signal data by multiplying each data of the fluorescent labels of the third fluorescence color signal data by the corresponding intensity correction coefficient; and
an output step of outputting the color signal data.
